(19) United States
(12) Patent Application Publication
(10) Pub. No.: US 2014/0188318 A1
(43) Pub. Date: Jul. 3, 2014

(54) MANAGING INTER-VEHICULAR BATTERY CHARGING TRANSACTIONS

(71) Applicant: International Business Machines Corporation, Armonk, NY (US)

(72) Inventors: John K. Langgood, Cary, NC (US); Thomas F. Lewis, Raleigh, NC (US); Kevin M. Reinberg, Chapel Hill, NC (US); Kevin S.D. Vernon, Durham, NC (US)

(73) Assignee: International Business Machines Corporation, Armonk, NY (US)

(21) Appl. No.: 13/954,737

(22) Filed: Jul. 30, 2013

Related U.S. Application Data
(63) Continuation of application No. 13/729,250, filed on Dec. 28, 2012.

(51) Int. Cl. B60L 11/18

(52) U.S. Cl. CPC B60L 11/1851
USPC 701/22; 705/39

(57) ABSTRACT

A computer implemented method includes receiving, from an inter-vehicular charge recipient having a recipient vehicle, a request to arrange an inter-vehicular charge and a battery charge level for the battery of the recipient vehicle. A battery charge level for a battery of the donor vehicle is received from an inter-vehicular charge donor vehicle, and an anticipated route of the donor vehicle and an anticipated route of the recipient vehicle is obtained. The battery charge level of the battery of the recipient vehicle is compared to the battery charge level of the battery of the donor vehicle to determine a suitability for inter-vehicular charging, and the anticipated route of the donor vehicle is compared to the anticipated route of the recipient vehicle to determine a location to initiate charging. The method then generates and sends a proposal for an inter-vehicular charge transaction to the donor vehicle.

### CROSS-REFERENCE TO RELATED APPLICATIONS

This application is a continuation of co-pending U.S. patent application Ser. No. 13/729,250, filed on Dec. 28, 2012.

### BACKGROUND OF THE INVENTION

1. Field of the Invention

The present invention relates to the management of inter-vehicular battery charging transactions.

2. Background of the Related Art

Battery-powered vehicles are increasingly popular among consumers that use these vehicles to travel generally short distances on a frequent basis, such as trips that may be characterized as an urban commute. While more stations designed for charging vehicle batteries are being built, these stations remain few and are often not on a convenient route for all users. Because it may be difficult to find a charging station, a user may find it necessary to charge their battery-powered vehicle to a full charge each night in order to accomplish the entirety of the next day's travels. Even unplanned side trips may need to be foregone for fear of the battery becoming exhausted and stranding the user with no way to recharge. These and other dynamics threaten to slow the adoption of electric-only, battery power vehicles.

### BRIEF SUMMARY OF THE INVENTION

One embodiment provides a computer implemented method that comprises receiving, from an inter-vehicular charge recipient having a recipient vehicle, a request to arrange an inter-vehicular charge and a battery charge level for the battery of the recipient vehicle; receiving, from an inter-vehicular charge donor vehicle, a battery charge level for a battery of the donor vehicle; and obtaining an anticipated route of the donor vehicle and an anticipated route of the recipient vehicle. The method further comprises comparing the battery charge level of the battery of the recipient vehicle to the battery charge level of the battery of the donor vehicle to determine a suitability for inter-vehicular charging, and comparing the anticipated route of the donor vehicle to the anticipated route of the recipient vehicle to determine a location to initiate charging. The method then generates and sends a proposal for an inter-vehicular charge transaction to the donor vehicle.

### BRIEF DESCRIPTION OF THE SEVERAL VIEWS OF THE DRAWINGS

FIG. 1 is a diagram of a battery-powered vehicle equipped to receive and send data and information to enable an inter-vehicular charge transaction to be arranged and/or managed by a user in accordance with an embodiment of the present invention.

FIG. 2 is a diagram of the battery-powered vehicle of FIG. 1.

FIG. 3 is a diagram of a user interface for selecting a donor vehicle from among a plurality of candidate battery-powered donor vehicles.

FIG. 4 is an illustration of a donor battery-powered vehicle charging a recipient battery-powered vehicle.

FIG. 5 is a block diagram of one embodiment of a computer node that may be used to enable an embodiment of the method of the present invention.

FIG. 6 is a flow chart of a method in accordance with one embodiment of the present invention.

### DETAILED DESCRIPTION OF THE INVENTION

One embodiment provides a computer implemented method that comprises receiving, from an inter-vehicular charge recipient having a recipient vehicle, a request to arrange an inter-vehicular charge and a battery charge level for the battery of the recipient vehicle; receiving, from an inter-vehicular charge donor vehicle, a battery charge level for a battery of the donor vehicle; and obtaining an anticipated route of the donor vehicle and an anticipated route of the recipient vehicle. The method further comprises comparing the battery charge level of the battery of the recipient vehicle to the battery charge level of the battery of the donor vehicle to determine a suitability for inter-vehicular charging, and comparing the anticipated route of the donor vehicle to the anticipated route of the recipient vehicle to determine a location to initiate charging. The method then generates and sends a proposal for an inter-vehicular charge transaction to the donor vehicle. In a first option, the proposal includes the determined location. In a second option, the request to arrange an inter-vehicular charge includes a requested amount of charge.

In another embodiment, the method may further comprise determining the amount of overlap between the anticipated route of the donor vehicle and the anticipated route of the recipient vehicle, wherein the proposal for the inter-vehicular charge transition describes the amount of charge that may be transferred during inter-vehicular charging in motion as the donor and recipient vehicles move together along the overlapping routes. Accordingly, the proposal may identify the overlap between the two routes to enable the donor to select a location to initiate charging.

In yet another embodiment, the method further comprises receiving an acceptance from the inter-vehicular charge donor, and sending an instruction to the recipient vehicle, wherein the instruction includes contact information for the inter-vehicular charge donor. The contact information may be a mobile telephone number or the location selected or agreed to by the donor.

In a further embodiment, the method may further include receiving at least one of an updated or changed battery charge level for the recipient vehicle and an updated or changed battery charge level for the donor vehicle. Optionally, the method may then electronically debit an account associated with the recipient vehicle in an amount of consideration for receiving the inter-vehicular battery charge, and electronically credit an account for the donor vehicle in an amount of consideration for the charging of the battery of the recipient vehicle.

The amount of consideration (payment) between the recipient and the donor may be determined at a fixed rate (price per unit of charge, etc.) or at a rate to be negotiated between the recipient and the donor prior to acceptance. According to one embodiment, donors may set their own charges to reflect their current personal schedule, distance and inconvenience to meet the recipient, and the amount of battery charge that the recipient has requested. Similarly, the consideration proposed by each prospective donor may then be displayed to the recipient, which will select one of the donors to reflect their own price sensitivity and the urgency of the charge or the close proximity of the donor.

In a still further embodiment, the method may further comprise receiving, from a device in communication with a plurality of global positioning satellites, data identifying the location of at least one of the recipient vehicle and the donor vehicle, and sending, to a device on board the other of the recipient vehicle and the donor vehicle, data identifying the location for the at least one of the recipient vehicle and the donor vehicle. This sharing of information enables one or both of the recipient, operating the recipient vehicle, and the donor, operating the donor vehicle, to locate one another and to thereafter connect the battery of the recipient vehicle to the battery of the donor vehicle to initiate the inter-vehicular charge. The device that communicates with the plurality of global positioning satellites may be one of a smart phone, a personal digital assistant and a navigational device, all of which are commonly carried on the person of an operator of the recipient vehicle and/or the donor vehicle or within the vehicles as part of the vehicle's navigational system and/or communication system. In a preferred embodiment of the method, both the recipient vehicle and the donor vehicle have such devices on board, and the location of the recipient vehicle is sent to the device on board the donor vehicle and the location of the donor vehicle is sent to the device on board the recipient vehicle.

In addition, the method may further include receiving, from at least one of the recipient vehicle and donor vehicle, a signal indicating that the battery of the recipient vehicle has been connected to the battery of the donor vehicle to provide an inter-vehicular charge. It will be understood that the receiving of the signal would be an event that indicates a successful end to a “set-up phase” of the inter-vehicular charge transaction and an event that begins the “battery charging phase” of the inter-vehicular charge transaction.

In an optional aspect of the method, the anticipated route of the donor vehicle and/or the anticipated route of the recipient vehicle may obtained by accessing a database containing historical data pertaining to the past routes of a plurality of subscribing inter-vehicular charge donor vehicles. The method may then select, from among the donor vehicles in the database, an inter-vehicular charge donor vehicle satisfying criteria for availability along some overlapping portion of the routes and criteria for a sufficient battery charge level for the proposed inter-vehicular charge. Maximizing the overlapping portion of the routes to be traversed by the recipient and donor vehicles will maximize the available duration of the inter-vehicular charge in motion and, therefore, the amount of energy transferred from the battery of the donor vehicle to the battery of the recipient vehicle.

An embodiment of the above-described method may further include receiving, from a device in communication with a plurality of global positioning satellites, data identifying the location of at least one of the recipient vehicle and the donor vehicle, and sending, to a device on board the other of the recipient vehicle and the donor vehicle, data identifying the location of the at least one of the recipient vehicle and the donor vehicle. Optionally, the method may further include receiving, from devices in communication with a plurality of global positioning satellites, data identifying the locations of both the recipient and donor vehicles and sending, to devices on board both the recipient and donor vehicles, data identifying the locations of the recipient and donor vehicles. According to this option, the operator of the donor vehicle may, for example, have a screen or display providing an automatically updated visual indication of the location of the recipient vehicle and the operator of the recipient vehicle may have a screen or display providing an automatically updated visual indication of the location of the donor vehicle. This information is useful in enabling the operators of the recipient and donor vehicles to locate one another and to thereafter connect the batteries of the recipient and donor vehicles to initiate inter-vehicular charging.

The device(s) in communication with a plurality of global positioning satellites, as set out in the above-described method, can comprise smart phone(s), personal digital assistant(s) or navigational device(s). In a preferred method, both of the recipient and donor vehicles have such a device on board, and data identifying the location of the donor vehicle is provided to the device on board the recipient vehicle and data identifying the location of the recipient vehicle is provided to the device on board the donor vehicle.

Another embodiment of the method may further include receiving, from at least one of the recipient vehicle and the donor vehicle, a signal indicating that the batteries of the recipient vehicle and donor vehicle have been connected for an inter-vehicular charge. It will be understood that such a signal may be received from each of the recipient and donor vehicles such that a second signal becomes a confirmation of the information provided through the first signal.

As with other embodiments, the method may include selecting a donor vehicle from among a plurality of donor vehicle candidates, or subscribers, based on specific criteria. For example, but not by way of limitation, the method may include accessing a database of prospective inter-vehicular charge donors that travel along an overlapping portion of the anticipated route of the recipient vehicle. A prospective inter-vehicular charge donor may be selected using criteria indicating availability for the proposed inter-vehicular charge, a sufficient battery charge level, and receipt of a favorable response to the inquiry. It will be understood that this process can be used to ensure the selection of a donor vehicle having a substantially extended common leg in order to maximize the duration of the inter-vehicular charge and, at the same time, this process can be used to ensure the selection of a donor vehicle having a favorable battery charge level to meet the charging needs of the recipient vehicle to enable the battery of the recipient's vehicle to be charged in an amount sufficient to power the recipient's vehicle so that it will reach the recipient's anticipated destination.

In a different embodiment, an electrical connection between the recipient vehicle and the donor vehicle comprises conductive connections, between the positive terminals and the negative terminals of the batteries of the recipient's vehicle and the donor's vehicle, and a tow connection such as a tow bar or tow chain. In one embodiment, the conductive connections are integrated into the tow connection. For example, but not by way of limitation, a tow connection may comprise a receptacle on the rear of the donor vehicle having a generally funnel-shaped guide to engage and steer a generally bullet-shaped insert on the front of the recipient vehicle to a capture position within the center of the receptacle. The insertion of the insert into the receptacle locks the insert to connect the donor vehicle to the recipient vehicle and to provide a robust physical connection there between to enable the donor vehicle to tow the recipient vehicle during the inter-vehicular charge. A first portion of the insert is conductively connected to the positive terminal on the battery of the recipient vehicle and a second portion of the insert is conductively connected to the negative terminal of the battery of the recipient vehicle. The receptacle includes a first portion conductively connected to the positive terminal of the battery of the donor vehicle that engages the first portion of the insert when the insert is received into the receptacle to the locked position, and the receptacle further includes a second portion conductively connected to the negative terminal of the battery of the donor vehicle that engages the second portion of the insert when the insert is received into the receptacle to the locked position. This embodiment provides for automatically connecting the battery terminals of the battery of the recipient vehicle to the battery terminals of the battery of the donor vehicle when the recipient vehicle is physically connected to the donor vehicle to enable the donor vehicle to tow the recipient vehicle while the inter-vehicular charge is in progress. In one such embodiment, the receptacle may include a canal having a first conductive brush section and a second conductive brush section to receive and engage the first portion of the insert and the second portion of the insert. It will be understood that current may flow through a plurality of conductive elements within the receptacle that are compliant and that elastically deform upon insertion of the insert and maintain the capacity to conduct current between the receptacle and the insert.

In one embodiment, the connection(s) between the recipient vehicle and the donor vehicle may be engaged and locked, and unlocked and disengaged, with minimal user interaction and on the roadway. It will be understood that, for example, the receptacle on the rear of a donor vehicle and an insert on the front of a recipient vehicle may be pre-positioned, relative to street-level, for mating engagement on a roadway without the need for manipulation or positioning by a human. The funnel-shaped configuration of the receptacle and the bullet-shaped configuration of the insert may cooperate to force alignment between a mis-aligned insert and receptacle. In other embodiments, a small camera may be mounted on the rear of the donor vehicle, on the front of the recipient vehicle, or both, and a motorized positioning system may be used to enable one of the donor and the recipient to steer the insert into the receptacle, or to steer the receptacle onto the insert, for making up the connection.

In another embodiment, the connections between the recipient vehicle and the donor vehicle further comprise control connections. For example, but not by way of limitation, a control connection may connect the brake system of a leading donor vehicle with the brake system of a trailing recipient vehicle so that, as the inter-vehicular charge is in progress through the conductive connections and as the donor vehicle tows the recipient vehicle through the tow connection, the operator of the donor vehicle has simultaneous control over the braking system of the donor vehicle and the braking system of the recipient vehicle through a single brake pedal or brake lever in the donor vehicle. Similarly, in another embodiment, a control connection may connect the accelerator of a leading donor vehicle with the accelerator of a trailing recipient vehicle so that, as the inter-vehicular charge is in progress through the conductive connections and as the donor vehicle tows the recipient vehicle through the tow connection, the operator of the donor vehicle has simultaneous control over the accelerator of the donor vehicle and the accelerator of the recipient vehicle through a single accelerator in the donor vehicle. Similarly, in another embodiment, a control connection may connect a battery charge level indicator in a leading donor vehicle with the battery charge level sensor in a trailing recipient vehicle so that, as the inter-vehicular charge is in progress through the conductive connections and as the donor vehicle tows the recipient vehicle through the tow connection, the operator of the donor vehicle is able to monitor the battery charge level of the battery of the donor vehicle and disengage the recipient vehicle when the battery of the recipient vehicle has increased to a sufficient charge level or when the battery of the donor vehicle has decreased to a minimal charge level.

In an alternative embodiment, the connection between the terminals of the battery of a recipient vehicle and the terminals of the battery of a donor vehicle does not require contact. In this alternate embodiment, inductive charging is used to transfer energy from the battery of the donor vehicle to the battery of a recipient vehicle by using power from the donor vehicle to induce a current to flow in a charging portion of the recipient vehicle brought into close proximity to a charging portion of the donor vehicle. In a fundamental aspect, a transformer is separated into two parts, one on the recipient vehicle and one on the donor vehicle. When the portion of the transformer on the donor vehicle is brought into close proximity to the portion of the transformer on the recipient vehicle, the portion of the transformer on the donor vehicle induces a current to flow in the portion in the portion on the recipient vehicle to charge the battery on the recipient vehicle. This mode of energy transfer from a donor vehicle to a recipient vehicle is a modification of the mode of energy transfer used by Plugless Power™ in a family of Electric Vehicle Supply Equipment products manufactured by Evatran®. However, an induction transformer charging system is substantially less efficient than a charging system requiring a hard-wired connection due to large power losses in the transformer.

Data and information may be transmitted between the recipient, the donor (or prospective donors) and the electronic devices used to arrange and/or monitor the inter-vehicular charge transaction using cellular telephone systems, MMS or email via Internet. In a preferred embodiment, the transfer of data and information is through portable devices that communicate with satellites, such as those offered and sold by On Star, LLC, Sirius XM Radio, Inc., Garmin Switzerland GmbH Corporation and other companies that operate systems for sending and receiving data to and from portable and mobile devices.

The portable on-board device used to transmit and receive data and information to enable the method of the present invention may be carried on the person of the operator of the vehicle or installed in or carried in the vehicle. The device is programmable to eliminate the need for repeated human involvement in the monitoring or reporting of the battery charge level, vehicle position and/or the anticipated destination. For example, but not by way of limitation, an on-board battery monitoring system may be in communication with a satellite-based receiver, and programmed to send a battery charge level signal to the receiver at predetermined intervals once the battery charge level falls below a predetermined threshold charge level such as, for example, 40% of full charge. In this event, the data relating to the battery charge level of the vehicle to be operated by the prospective inter-vehicular charge recipient may already be accessible to the server or computer that receives the request for arrangement of an inter-vehicular charge from the prospective recipient. As another example, a navigational device can be programmed to cooperate with the system or it can be incorporated into the system and programmed to recall a list of destinations to which the vehicle or the recipient frequently travels.

The step of receiving the anticipated route from the prospective inter-vehicular charge recipient may also be provided by cell phone, MMS or email, but may also be provided by way of a portable electronic device on-board the vehicle in communication with a satellite-based receiver. For example, but not by way of limitation, the prospective inter-vehicular charge recipient may simply generate the request for arrangement of an inter-vehicular charge by entering into a navigational device on-board the vehicle his or her anticipated destination.

Another embodiment provides a computer program product embodied on a tangible computer usable storage medium, the computer program product comprising computer usable program code for receiving, from an inter-vehicular charge recipient having a recipient vehicle, a request to arrange an inter-vehicular charge and a battery charge level for the battery of the recipient vehicle; computer usable program code for receiving, from an inter-vehicular charge donor vehicle, a battery charge level for a battery of the donor vehicle; computer usable program code for obtaining an anticipated route of the donor vehicle and an anticipated route of the recipient vehicle; computer usable program code for comparing the battery charge level of the battery of the recipient vehicle to the battery charge level of the battery of the donor vehicle to determine a suitability for inter-vehicular charging; computer usable program code for comparing the anticipated route of the donor vehicle to the anticipated route of the recipient vehicle to determine a location to initiate charging; and computer usable program code for generating and sending a proposal for an inter-vehicular charge transaction to the donor vehicle. It should be recognized that the computer program product may include further computer usable program code to control or implement any one or more step or other aspect of the methods described herein.

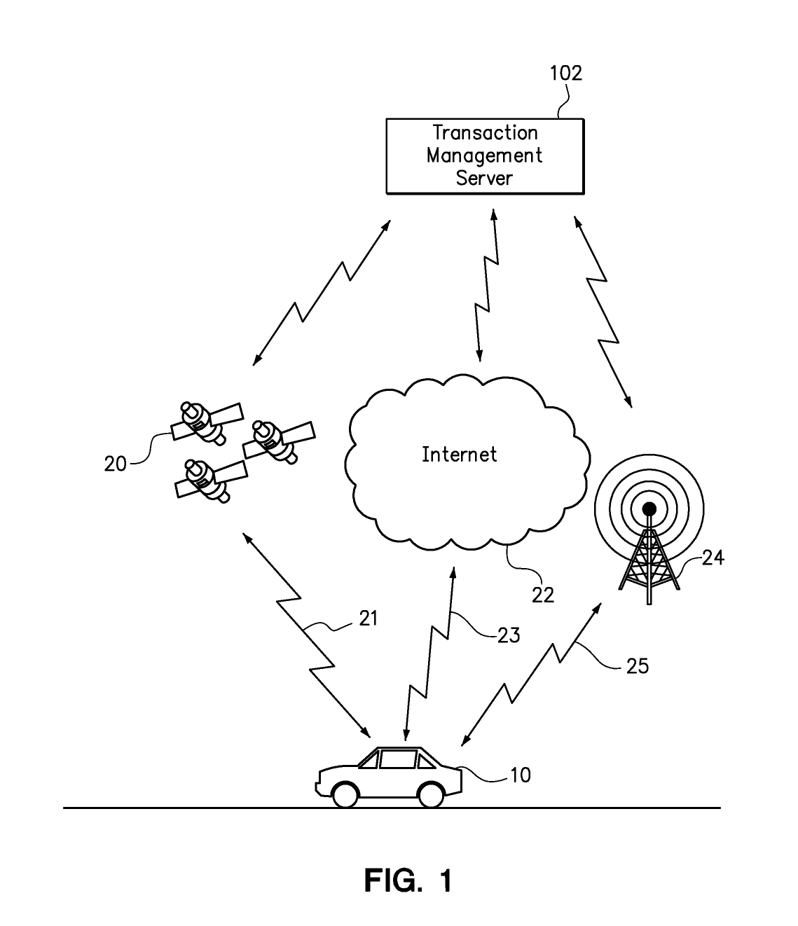

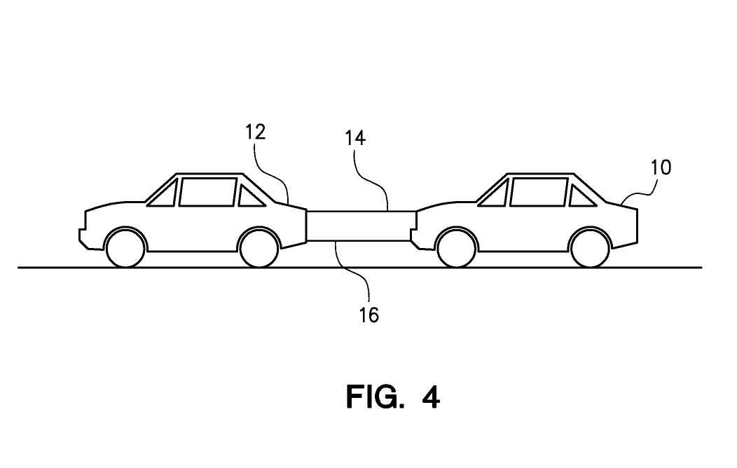

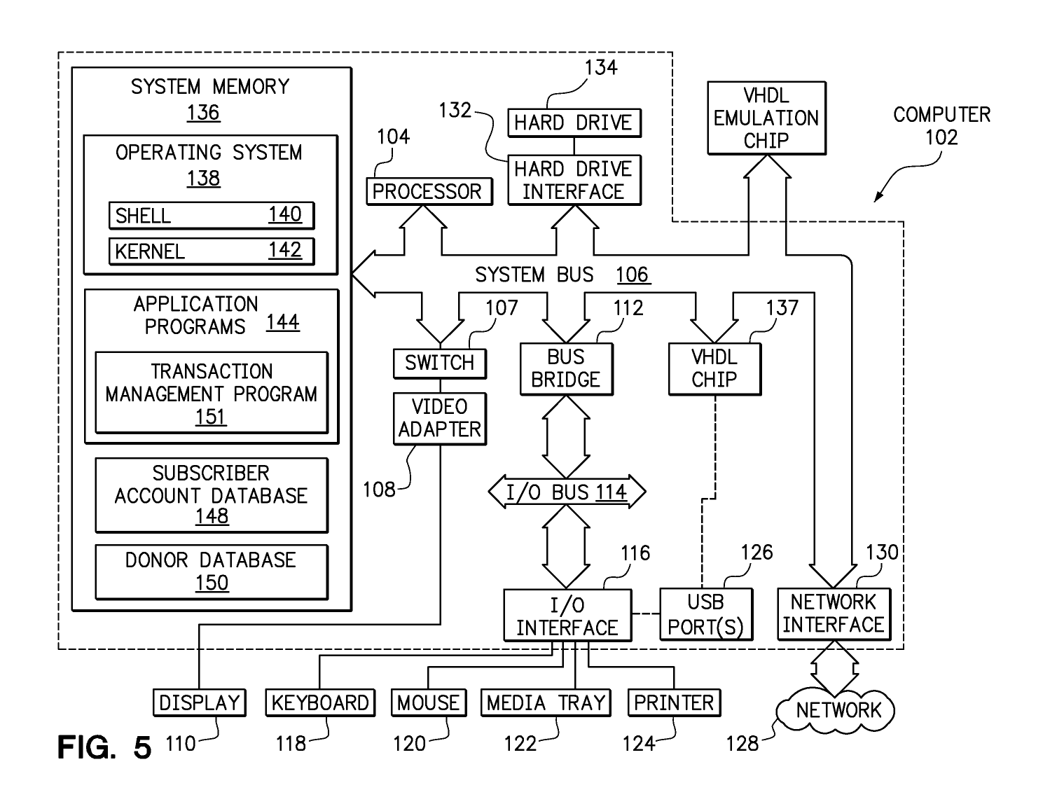

FIG. 1 is a diagram of a battery-powered inter-vehicular charge recipient vehicle 10 communicating information to initiate an inter-vehicular charge transaction to be managed using an embodiment of the method of the present invention. In a first mode, the recipient vehicle 10 communicates wirelessly with orbiting satellites 20 by generating a satellite signal 21 that is detected by the orbiting satellites 20. In a second mode, the recipient vehicle 10 communicates wirelessly with the Internet 22 by generating a signal 23 that is detected by one or more wireless fidelity (WiFi) networks. In a third mode, the recipient vehicle 10 communicates with one or more distributed cell phone towers 24 by generating a signal 25 that is received by the one or more cellular telephone towers 24. In all of the three modes of communication, the signal 21, 23, 25 is relayed to circuits (not shown) designated by the signal 21, 23, 25, and passed along to a transaction management server 102 dedicated to managing the method of the present invention and generating responsive signals, instructions and/or inquiries. It will be understood that other modes of uploading data and information from the recipient vehicle 10 to the server 102 and downloading data and information from the server 102 to the recipient vehicle 10 may involve a combination of the modes illustrated in FIG. 1. For example, but not by way of limitation, the distributed cell phone towers 24 may be used to relay the signal 25 from the recipient vehicle 10 through the Internet 22 to the server (see FIG. 5), and the cell phone towers 24 may be used to relay data and information from the server (see FIG. 5) through the Internet 22 to the recipient vehicle 10. It will be understood that the modes of communication illustrated in FIG. 1 may also be utilized for communications between the server 102 and a donor vehicle 12 (see FIG. 4) or a prospective donor vehicle.

The request of the operator of the recipient vehicle 10, along with the battery charge level and the anticipated route of the recipient vehicle 10, can be communicated using one or a combination of the available modes illustrated in FIG. 1 to the remote server 102 for processing and for the generation of instructions, signals and/or inquires, and for the execution of computer code for selecting an available donor vehicle having a satisfactory battery charge level and an overlapping portion of a route.

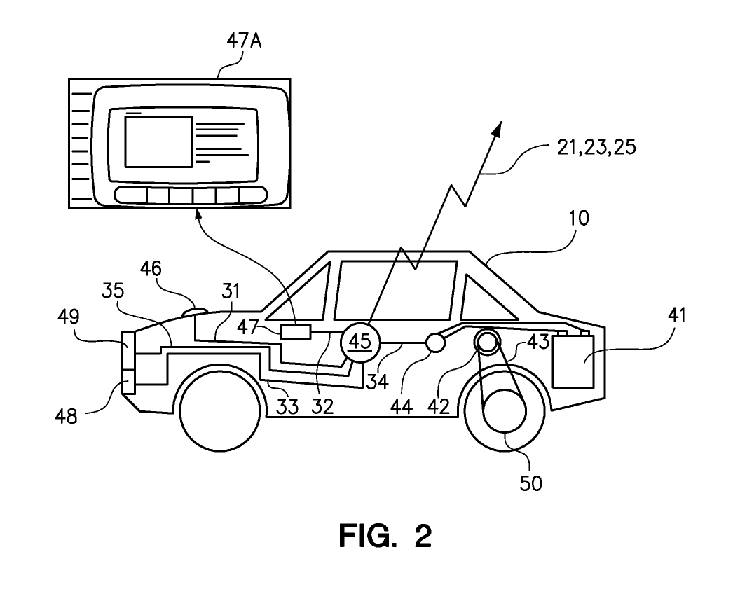

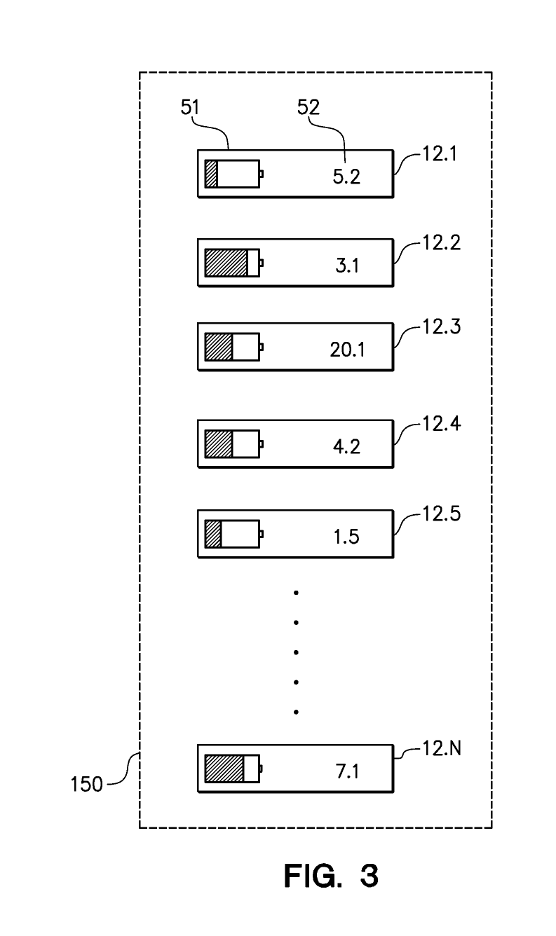

FIG. 2 is one example of a recipient vehicle 10 (see FIG. 1) in accordance with various embodiments of the present invention. Generally, the recipient vehicle 10 is provided with on board devices enabling audio, visual, and/or telephonic communication with orbiting satellites, the Internet and/or cellular telephone towers, including the transmission of data via one or all of these modes illustrated in FIG. 1. The recipient vehicle 10 of FIG. 2 includes a visual display screen 47 (enlarged view 47A) to display maps, messages and instructions to the operator of the recipient vehicle 10. The screen 47 may be touch-sensitive to enable the operator of the recipient vehicle 10 to input and automatically upload selections, data and responses to questions or proposed inter-vehicular transactions. The recipient vehicle 10 of FIG. 2 further includes a battery 41 conductively connected to a motor 42. The motor 42 is connected to a wheel sprocket 50 using a drive member, such as a chain 43 or a drive shaft. A battery charge level sensor 44 is connected to the battery 41 to generate a battery charge level signal 34 to a processor/transmitter/receiver 45 for transmission to a server (see FIG. 5) using one or more of the communication modes illustrated in FIG. 1. The recipient vehicle 10 of FIG. 2 further includes a global positioning system (GPS) transponder 46 to generate a signal 31 to the processor/transmitter/receiver 45, using triangulation among three or more global positioning satellites 20 (see FIG. 1), indicating the location of the recipient vehicle 10. It will be understood that a similar system on a donor vehicle 12 enables the determination and sharing of the location of the donor vehicle 12 (see FIG. 3).

The recipient vehicle 10 of FIG. 2 further includes a tow connection sensor 48 to generate a signal 33 to the processor/transmitter/receiver 45 and a control cable connector 49 to generate a signal 35 to the processor/transmitter/receiver 45. The use of the tow connection sensor 48 and the control cable connector 49 will be discussed in more detail in connection with FIG. 4.

The processor/transmitter/receiver 45 can upload and/or receive data and information through signals 21, 23 and/or 25 to and from a plurality of satellites 20, the Internet 22 and/or distributed cellular telephone towers 24 as illustrated in more detail in FIG. 1.

FIG. 3 is a diagram of a user interface 50 for selecting a donor vehicle from among a plurality of candidate battery-powered donor vehicles 12.1, 12.2, 12.3, 12.4, 12.5 to 12.N in accordance with one or more embodiments of the present invention. For example, the user interface 50 may be displayed on the visual display screen 47 (enlarged view 47A) shown in FIG. 2. The user interface 50 provides a screen for the selection of a compatible donor vehicle 12 (not shown in FIG. 3). Candidate donor vehicles that are available are still filtered out and not shown if they have a low battery charge level (see battery icon in column 51) or have a separation distance (see mileage in column 52) indicating that the candidate (one of 12.1-12.N) is remote from the recipient vehicle 10 or from an overlapping portion of an anticipated route of the recipient vehicle 10. It will be understood that other factors and considerations may be used to filter out candidates such as, for example, an unsatisfactory reliability rating, the lack of an overlapping portion in an anticipated route of the recipient vehicle 10 and the candidate 12.1-12.N. After the filtering of candidates based on these or other criteria, a prospective candidate may be selected from among the unfiltered candidates 12.1-12.N remaining based on battery charge level 51, distance 52 from the recipient vehicle 10 (or proximity), the amount of energy needed by the recipient vehicle 10 to reach an anticipated destination, the anticipated time for the candidate to travel to a location to initiate charging based on current traffic conditions and other factors. For example, candidates 12.2 and 12.4 on FIG. 3 may comprise the two most eligible candidates.

In one embodiment of the method and computer program product of the present invention, a candidate 12.1-12.N is selected and information relating to a proposed inter-vehicular charge transaction is sent to the selected candidate using, for example, one of the modes of communication illustrated in FIG. 1. If the proposed inter-vehicular charge transaction is accepted by the selected candidate, the candidate becomes the donor vehicle 12 and instructions are sent to the recipient vehicle 10 and to the donor vehicle 12 for a rendezvous to connect the vehicles 10 and 12 as illustrated in FIG. 4.

FIG. 4 illustrates a leading donor vehicle 12 charging a trailing recipient vehicle 10 in an inter-vehicular charge transaction arranged using an embodiment of the method and computer program product of the present invention. The donor vehicle 12 is connected to the recipient vehicle 10 through a tow connection, such as a tow bar 16, and through a conductive connection, such as a coaxial cable 14. Tow bars and releasable tow bars are known in the art, as are coaxial cables.

In one embodiment, the connections between the leading donor vehicle 12 and the trailing recipient vehicle 10 include an electronic connection (not shown) that links certain operator control components in the donor vehicle 12 with certain controllable systems of the recipient vehicle 10 such as, for example, linking the brake pedal of the donor vehicle 12 with the brake system of the recipient vehicle 10, linking the accelerator of the donor vehicle 12 with the motor of the recipient vehicle 10 and linking the blinkers, brake lights and emergency flashers of the donor vehicle 12 with the exterior blinker lights and brake lights on the recipient vehicle 10. In one embodiment, a battery charge level monitor in the donor vehicle 12 may be linked to the battery 41 (see FIG. 2) being charged in the recipient vehicle 10. Control of vehicle systems in the recipient vehicle 10 by the operator of the donor vehicle 12 may be provided by connecting a control module 49 (see FIG. 2) on the donor vehicle 10 to a corresponding control module on the donor vehicle 12 and providing a signal 35 (see FIG. 2) from the corresponding control module on the donor vehicle 12 to the control module 49 on the recipient vehicle 10 and to the processor/transmitter/receiver 45 on the recipient vehicle 10 that, in turn, controls the brake system, motor, etc.

The battery of the donor vehicle 12 charges the battery of the recipient vehicle 10 through conductive leads within the coaxial cable 14. In one embodiment, a coupling sensor 48 (see FIG. 2) may be provided on the recipient vehicle 12 to generate a signal 33 to a processor/transmitter/receiver 45 to enable the physical linking of the donor vehicle 12 and the recipient vehicle 10 to be electronically detectable by the server 102 (see FIG. 1).

FIG. 5 is a block diagram of an exemplary computer node 102 which may be utilized to implement embodiments of the present invention. The computer node 102 may be a stand-alone computer, server, or a plurality of integrated stand-alone computing devices. Computer node 102 includes a processor unit 104 that is coupled to a system bus 106. Processor unit 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below) external USB port(s) 126. While the format of the ports connected to I/O interface 116 may be any known to those skilled in the art of computer architecture, in a preferred embodiment some or all of these ports are universal serial bus (USB) ports.

As depicted, the computer node 102 is able to communicate with other computer nodes and devices via network 128 using a network interface 130. The network 128 may be an external network such as the Internet 22 (see FIG. 1), or an internal network such as an Ethernet or a virtual private network (VPN).

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as a lowest level of volatile memory in the computer 102. This volatile memory includes additional higher levels of volatile memory (not shown), including, but not limited to, cache memory, registers and buffers. Data that populates the system memory 136 includes the operating system (OS) 138 and application programs 144 of the computer node 102.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while the shell 140 is a text-based, line-oriented user interface, the present invention will equally well support other user interface modes, such as graphical, voice, gestural, etc.

As depicted, the operating system 138 also includes kernel 142, which includes lower levels of functionality for the operating system 138, including providing essential services required by other parts of the operating system 138 and application programs 144, including memory management, process and task management, disk management, and mouse and keyboard management.

Application programs 144 in the system memory of the computer node 102 include a transaction management program 151 that is able to access data in the subscriber account database 148, which stores subscriber identifications and account data, and the donor database 150.

Optionally also stored in the system memory 136 is a VHDL (VHSIC hardware description language) program. VHDL is an exemplary design-entry language for field programmable gate arrays (FPGAs), application specific integrated circuits (ASICs), and other similar electronic devices. In one embodiment, execution of instructions from the transaction management program 151 causes the VHDL program to configure VHDL chip, which may be an FPGA, ASIC, etc.

The hardware elements depicted in the computer node 102 are not intended to be exhaustive, but rather are representative to highlight essential components required by the present invention. For instance, computer node 102 may include alternate memory storage devices such as magnetic cassettes, digital versatile disks (DVDs), Bernoulli cartridges, and the like. These and other variations are intended to be within the spirit and scope of the present invention.

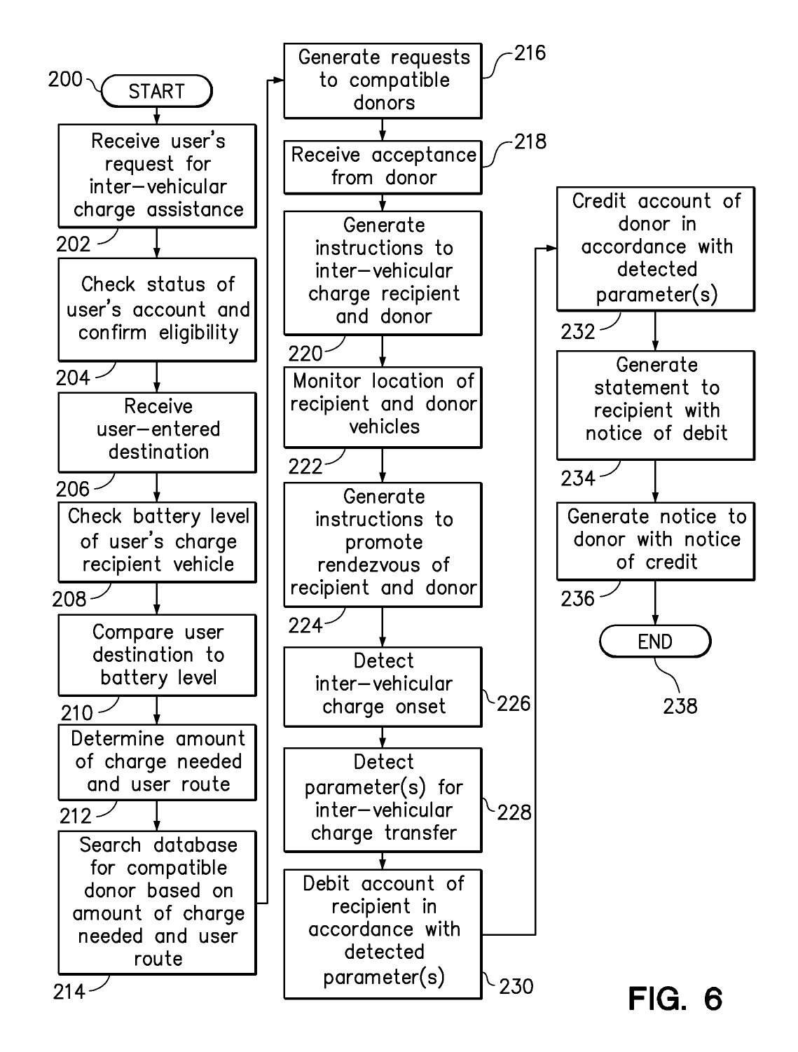

FIG. 6 is a high-level flow chart illustrating the steps 200-238 of an embodiment of the method of the present invention. The embodiment of the method begins at step 200 and, in step 202, a user's request for inter-vehicular charge assistance is received. In step 204, the status of the requesting user's account and eligibility for inter-vehicular charge assistance is checked. In step 206, the user's anticipated route is received. In step 208, the battery level of the user's recipient vehicle is received. In some embodiments, step 206 and step 208 may be combined with step 202. In step 210, the user's anticipated route is compared to the user's recipient vehicle's battery level. In step 212, a route for the user to take to reach his or her anticipated destination is determined and a corresponding level of battery charge is determined. In step 214, which is illustrated in FIG. 3, a database containing data relating to a plurality of candidate donor vehicles is searched according to a compatible route and battery level for engaging the user's recipient vehicle for an inter-vehicular charge transaction. In step 216, one or more requests for inter-vehicular charge candidates selected from among candidate donor vehicles in the database are generated and sent. In step 218, an acceptance from a prospective donor vehicle is received. In step 220, instructions for the inter-vehicular charge recipient (user) and the inter-vehicular charge donor are generated and sent. In step 222, the locations of the recipient (user's) vehicle and the donor's vehicle are monitored. In step 224, instructions to rendezvous at a location, for example, a rendezvous location that has been determined based on the routes of the recipient's and donor's anticipated destinations and/or routes, are generated and sent to the recipient and donor. In step 226, the onset of an inter-vehicular charge is detected, for example, by a battery level sensor on board at least one of the recipient vehicle and the donor vehicle and by wireless communication of the signal from the sensor to a monitoring server used to implement the method illustrated in FIG. 6. In step 228, parameters relating to the inter-vehicular charge are detected, for example, a revised and increased battery charge level for the recipient vehicle and a revised and decreased battery charge level for the donor vehicle. In step 230, an account of the recipient is debited in accordance with parameters relating to a detected inter-vehicular charge and, in step 232, an account of the donor is credited in accordance with parameters relating to the detected inter-vehicular charge. In step 234, a statement to the recipient with notification of the amount debited against recipient's account is generated and sent to the recipient and, in step 236, a statement to the donor with notification of the amount credited to donor's account is generated and sent to the donor. Finally, in step 238, the inter-vehicular charge transaction is completed and the embodiment of the method illustrated in FIG. 6 terminates.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer implemented method, comprising:
receiving, from an inter-vehicular charge recipient having a recipient vehicle, a request to arrange an inter-vehicular charge and a battery charge level for the battery of the recipient vehicle;
receiving, from an inter-vehicular charge donor vehicle, a battery charge level for a battery of the donor vehicle;
obtaining an anticipated route of the donor vehicle and an anticipated route of the recipient vehicle;
comparing the battery charge level of the battery of the recipient vehicle to the battery charge level of the battery of the donor vehicle to determine a suitability for inter-vehicular charging;
comparing the anticipated route of the donor vehicle to the anticipated route of the recipient vehicle to determine a location to initiate charging; and
generating and sending a proposal for an inter-vehicular charge transaction to the donor vehicle.

2. The computer implemented method of claim 1, wherein the proposal includes the determined location.

3. The computer implemented method of claim 1, wherein the request to arrange an inter-vehicular charge includes a requested amount of charge.

4. The computer implemented method of claim 1, further comprising:
determining the amount of overlap between the anticipated route of the donor vehicle and the anticipated rout of the recipient vehicle, wherein the proposal for the inter-vehicular charge transition describes the amount of charge that may be transferred during inter-vehicular charging in motion as donor and recipient vehicles move together along the overlapping routes.

5. The computer implemented method of claim 1, further comprising:
receiving an acceptance from the inter-vehicular charge donor vehicle; and
sending an instruction to the recipient vehicle, wherein the instruction includes contact information for the inter-vehicular charge donor vehicle.

6. The computer implemented method of claim 1, further comprising:
receiving at least one of a changed battery charge level for the recipient vehicle and a changed battery charge level for the donor vehicle; and
at least one of electronically debiting an account for the recipient vehicle in an amount of consideration for receiving the inter-vehicular charging of the battery of the recipient vehicle and electronically crediting an account for the donor vehicle in an amount of consideration for the charging of the battery of the recipient vehicle.

7. The computer implemented method of claim 1, further comprising:
receiving, from a device in communication with a plurality of global positioning satellites, data identifying the location of at least one of the recipient vehicle and the donor vehicle; and
sending, to a device on board the other of the recipient vehicle and the donor vehicle, data identifying the location for the at least one of the recipient vehicle and the donor vehicle.

8. The computer implemented method of claim 7, wherein the device in communication with a plurality of global positioning satellites comprises one of a smart phone, a personal digital assistant, and a navigational device.

9. The computer implemented method of claim 1, further comprising:
receiving, from a donor device in communication with a plurality of global positioning satellites, data identifying the location of the donor vehicle; and
receiving, from a recipient device in communication with a plurality of global positioning satellites, data identifying the location of the recipient vehicle.

10. The computer implemented method of claim 1, further comprising:
sending data identifying the location of the recipient vehicle to a device on board the donor vehicle; and
sending data identifying the location for the donor vehicle to a device on board the recipient vehicle.

11. The computer implemented method of claim 1, further comprising:
receiving, from at least one of the recipient vehicle and donor vehicle, a signal indicating that the battery of the recipient vehicle has been connected to the battery of the donor vehicle to provide an inter-vehicular charge.

12. The computer implemented method of claim 1, further comprising:
accessing a database of inter-vehicular charge donor vehicles that frequently travel a leg of a route to the anticipated destination of the recipient vehicle; and
selecting from among the donor vehicles in the database an inter-vehicular charge donor vehicle satisfying criteria for availability along some portion of the common leg and battery charge level for the proposed inter-vehicular charge.

13. The computer implemented method of claim 1, further comprising:
receiving a response from the donor vehicle setting a price for the proposed inter-vehicular charge transaction; and
allowing the recipient vehicle to accept or decline the proposed inter-vehicular charge transaction at the price set by the donor vehicle.
